(19) United States
(12) Patent Application Publication
(10) Pub. No.: US 2026/0018834 A1
(43) Pub. Date: Jan. 15, 2026

(54) Electrical Connector

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/239,393

(22) Filed: Jun. 16, 2025

(30) Foreign Application Priority Data
Jul. 12, 2024 (TW) 113207546

(51) Int. Cl. H01R 13/6585; H01R 13/6599

(52) U.S. Cl. CPC H01R 13/6585; H01R 13/6599

(57) ABSTRACT

An electrical connector comprising a major shielding conductive terminal, a major non-shielding conductive terminal, a minor shielding conductive terminal, a minor non-shielding conductive terminal, and a conductive shielding material component. The conductive shielding material component is disposed between the major conductive terminal and the minor-side conductive terminal, and comprises a conductive plastic material and a conductive metal material, wherein the conductive plastic material, the conductive metal material, the major shielding conductive terminal, and the minor shielding conductive terminal are electrically connected to transmit shielding signals. Thus, the conductive plastic material, the conductive metal material, the major shielding conductive terminal, and the minor shielding conductive terminal provide shielding for the signal transmission between the major non-shielding conductive terminal and the minor non-shielding conductive terminal. In this manner, interference encountered by the electrical connector during high-speed signal transmission can be effectively reduced, thereby optimizing the quality of high-speed signal transmission.

### CROSS-REFERENCE TO RELATED APPLICATIONS

This application claims the priority of Republic of China Patent Application No. 113207546 filed on Jul. 12, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector capable of reducing the degree of interference when transmitting high-speed signals.

### Descriptions of the Related Art

In recent years, electrical connectors have been widely applied to various electronic devices, wherein a plurality of conductive terminals on the electrical connector are utilized to transmit signals. However, along with the special demands and development of electronic devices, the plurality of conductive terminals of the electrical connector may also be required to transmit high-speed signals. Currently, when transmitting high-speed signals, the electrical connector is prone to being interfered with (wherein the interference may be, for example, electromagnetic interference from external environments or crosstalk interference coupled between the plurality of conductive terminals of the electrical connector), resulting in signal degradation of the transmitted high-speed signals.

From the above, it is known that how to solve the problem that the electrical connector is prone to interference when transmitting high-speed signals is indeed an urgent issue to be addressed by those skilled in the art.

### SUMMARY OF THE INVENTION

In view of the drawbacks of the prior art mentioned above, the present application provides An electrical connector comprising an electrical connector major side and an electrical connector minor side, the electrical connector comprising: a major shielding terminal component comprising a first major shielding conductive terminal, a second major shielding conductive terminal and a major shielding terminal conductive connector, wherein the major shielding terminal conductive connector is electrically connected to the first major shielding conductive terminal and the second major shielding conductive terminal respectively; a major non-shielding terminal component comprising a major non-shielding conductive terminal and a major non-shielding terminal component insulator, wherein the major non-shielding terminal component insulator is mated with the major non-shielding conductive terminal; a minor shielding terminal component comprising a first minor shielding conductive terminal, a second minor shielding conductive terminal and a minor shielding terminal conductive connector, wherein the minor shielding terminal conductive connector is electrically connected to the first minor shielding conductive terminal and the second minor shielding conductive terminal respectively; a minor non-shielding terminal component comprising a minor non-shielding conductive terminal and a minor non-shielding terminal component insulator, wherein the minor non-shielding terminal component insulator is mated with the minor non-shielding conductive terminal; a conductive shielding material component comprising a conductive plastic material and a conductive metal material, wherein the conductive plastic material is electrically mated with the conductive metal material to transmit shielding signals; wherein, the major non-shielding terminal component and the major shielding terminal component are respectively configured to be bridged across the conductive shielding material component and are respectively located at the electrical connector major side, wherein the major non-shielding terminal component insulator is configured to electrically isolate the major non-shielding conductive terminal from the conductive shielding material component to prevent electrical connection between the major non-shielding conductive terminal and the conductive shielding material component, and the major non-shielding terminal component insulator is further configured to electrically isolate the major non-shielding conductive terminal from the major shielding terminal component to prevent electrical connection between the major non-shielding conductive terminal and the major shielding terminal component; the major shielding terminal component is configured to be electrically inserted into the conductive plastic material to transmit shielding signals; the minor non-shielding terminal component and the minor shielding terminal component are respectively configured to be bridged across the conductive shielding material component and are respectively located at the electrical connector minor side, wherein the minor non-shielding terminal component insulator is configured to isolate the minor non-shielding conductive terminal from the conductive shielding material component to prevent electrical connection between the minor non-shielding conductive terminal and the conductive shielding material component, and the minor non-shielding terminal component insulator is further configured to isolate the minor non-shielding conductive terminal from the minor shielding terminal component to prevent electrical connection between the minor non-shielding conductive terminal and the minor shielding terminal component; the minor shielding terminal component is configured to be electrically inserted into the conductive plastic material to transmit shielding signals; and the conductive metal material is disposed between the major non-shielding terminal component and the minor non-shielding terminal component to provide shielding for signal transmission between the major non-shielding conductive terminal and the minor non-shielding conductive terminal.

Preferably, the electrical connector said above, wherein the conductive plastic material, the first major shielding conductive terminal and the second major shielding conductive terminal are configured to form a major conductive shielding body, wherein the major conductive shielding body comprises a U-shaped form, and the major conductive shielding body is extended near the major non-shielding conductive terminal; and the conductive plastic material, the first minor shielding conductive terminal and the second minor shielding conductive terminal are configured to form a minor conductive shielding body, wherein the minor conductive shielding body comprises a U-shaped form, and the minor conductive shielding body is extended near the major non-shielding conductive terminal.

Preferably, the electrical connector said above, further comprising an electrical connector core, wherein the electrical connector core is configured to be mated with the major shielding terminal component, the major non-shielding terminal component, the minor shielding terminal component, the minor non-shielding terminal component and the conductive shielding material component to form an electrical connector mating component.

Preferably, the electrical connector said above, wherein the conductive plastic material is configured to pass through the major non-shielding terminal component insulator and is configured to be electrically connected to the first major shielding conductive terminal and the second major shielding conductive terminal respectively, so as to transmit shielding signals and provide shielding for signal transmission of the major non-shielding conductive terminal; and the conductive plastic material is further configured to pass through the minor non-shielding terminal component insulator and is configured to be electrically connected to the first minor shielding conductive terminal and the second minor shielding conductive terminal respectively, so as to transmit shielding signals and provide shielding for signal transmission of the minor non-shielding conductive terminal.

Preferably, the electrical connector said above, wherein the conductive plastic material comprises a conductive plastic material inner space, and the conductive metal material is configured to be extended within the conductive plastic material inner space.

Preferably, the electrical connector said above, wherein the first major shielding conductive terminal and the second major shielding conductive terminal respectively comprise a first major shielding terminal inserting structure and a second major shielding terminal inserting structure, allowing the first major shielding terminal inserting structure and the second major shielding terminal inserting structure to be electrically inserted into the conductive plastic material respectively; and the first minor shielding conductive terminal and the second minor shielding conductive terminal respectively comprise a first minor shielding terminal inserting structure and a second minor shielding terminal inserting structure, allowing the first minor shielding terminal inserting structure and the second minor shielding terminal inserting structure to be electrically inserted into the conductive plastic material respectively.

Preferably, the electrical connector said above, wherein the major shielding terminal conductive connector comprises a major shielding terminal conductive connector inserting structure configured to be electrically inserted into the conductive plastic material to transmit shielding signals; and the minor shielding terminal conductive connector comprises a minor shielding terminal conductive connector inserting structure configured to be electrically inserted into the conductive plastic material to transmit shielding signals.

Preferably, the electrical connector said above, wherein the conductive plastic material comprises a major conductive plastic material inserting block and a minor conductive plastic material inserting block, allowing the major conductive plastic material inserting block and the minor conductive plastic material inserting block to respectively be electrically inserted into the major shielding terminal conductive connector inserting structure and the minor shielding terminal conductive connector inserting structure to transmit shielding signals.

Preferably, the electrical connector said above, configured to be mated with a joining component at an electrical connector joining end, wherein the electrical connector mating component comprises an electrical connector mating component joining portion, the major non-shielding conductive terminal comprises a major non-shielding conductive terminal joining structure, the first major shielding conductive terminal comprises a first major shielding terminal joining structure, and the second major shielding conductive terminal comprises a second major shielding terminal joining structure, wherein the major non-shielding terminal component insulator comprises a major non-shielding terminal component insulator terminal base, and the conductive plastic material comprises a first major conductive plastic material shielding terminal base and a second major conductive plastic material shielding terminal base, wherein the major non-shielding terminal component insulator terminal base is configured to support the major non-shielding conductive terminal, the first major conductive plastic material shielding terminal base is configured to support the first major shielding conductive terminal, and the second major conductive plastic material shielding terminal base is configured to support the second major shielding conductive terminal, such that the major non-shielding conductive terminal joining structure, the first major shielding terminal joining structure and the second major shielding terminal joining structure are respectively located at the electrical connector mating component joining portion to be mated with the joining component.

Preferably, the electrical connector said above, wherein the first major conductive plastic material shielding terminal base and the second major conductive plastic material shielding terminal base are configured to respectively pass through the major non-shielding terminal component insulator to respectively support the first major shielding conductive terminal and the second major shielding conductive terminal.

Preferably, the electrical connector said above, wherein the major shielding terminal conductive connector comprises a major shielding terminal conductive connector shielding structure located at the electrical connector joining end to provide shielding for signal transmission of the major non-shielding conductive terminal joining structure.

Preferably, the electrical connector said above, wherein the major shielding terminal conductive connector comprises a major shielding terminal conductive connector perforated structure located at the electrical connector joining end to provide impedance matching for signal transmission of the major non-shielding conductive terminal joining structure.

Preferably, the electrical connector said above, configured to be mated with a joining component at an electrical connector joining end, wherein the electrical connector mating component comprises an electrical connector mating component joining portion, the minor non-shielding conductive terminal comprises a minor non-shielding conductive terminal joining structure, the first minor shielding conductive terminal comprises a first minor shielding terminal joining structure, and the second minor shielding conductive terminal comprises a second minor shielding terminal joining structure, wherein the minor non-shielding terminal component insulator comprises a minor non-shielding terminal component insulator terminal base, and the conductive plastic material comprises a first minor conductive plastic material shielding terminal base and a second minor conductive plastic material shielding terminal base, wherein the minor non-shielding terminal component insulator terminal base is configured to support the minor non-shielding conductive terminal, the first minor conductive plastic material shielding terminal base is configured to support the first minor shielding conductive terminal, and the second minor conductive plastic material shielding terminal base is configured to support the second minor shielding conductive terminal, such that the minor non-shielding conductive terminal joining structure, the first minor shielding terminal joining structure and the second minor shielding terminal joining structure are respectively located at the electrical connector mating component joining portion to be mated with the joining component.

Preferably, the electrical connector said above, wherein the first minor conductive plastic material shielding terminal base is configured to pass through the minor non-shielding terminal component insulator to support the first minor shielding conductive terminal, and the second minor conductive plastic material shielding terminal base is configured to pass through the minor non-shielding terminal component insulator to support the second minor shielding conductive terminal.

Preferably, the electrical connector said above, wherein the minor shielding terminal conductive connector comprises a minor shielding terminal conductive connector shielding structure located at the electrical connector joining end to provide shielding for signal transmission of the minor non-shielding conductive terminal joining structure.

Preferably, the electrical connector said above, Preferably, the electrical connector said above,

Preferably, the electrical connector said above, wherein the major non-shielding terminal component insulator is configured to be mated with the conductive plastic material so as to maintain the major non-shielding terminal component bridged across the conductive shielding material component; and the minor non-shielding terminal component insulator is configured to be mated with the conductive plastic material so as to maintain the minor non-shielding terminal component bridged across the conductive shielding material component.

Preferably, the electrical connector said above, wherein the first major shielding conductive terminal and the second major shielding conductive terminal are configured to respectively abut the major non-shielding terminal component insulator so as to maintain the major non-shielding terminal component bridged across the conductive shielding material component; and the first minor shielding conductive terminal and the second minor shielding conductive terminal are configured to respectively abut the minor non-shielding terminal component insulator so as to maintain the minor non-shielding terminal component bridged across the conductive shielding material component.

Compared to the prior art, the electrical connector provided by the present application comprises a major shielding conductive terminal, a major non-shielding conductive terminal, a minor shielding conductive terminal, a minor non-shielding conductive terminal, and a conductive shielding material component. The conductive shielding material component is disposed between the major conductive terminal and the minor-side conductive terminal, and comprises a conductive plastic material and a conductive metal material, wherein the conductive plastic material, the conductive metal material, the major shielding conductive terminal, and the minor shielding conductive terminal are electrically connected to transmit shielding signals. Thus, the conductive plastic material, the conductive metal material, the major shielding conductive terminal, and the minor shielding conductive terminal provide shielding for the signal transmission between the major non-shielding conductive terminal and the minor non-shielding conductive terminal. In this manner, interference encountered by the electrical connector during high-speed signal transmission can be effectively reduced, thereby optimizing the quality of high-speed signal transmission to meet the special demands and development trends of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of an electrical connector according to an embodiment of the present application from a first viewing angle.

FIG. 2 is a perspective schematic view of an electrical connector according to an embodiment of the present application from a second viewing angle.

FIG. 3 is a top schematic view of an electrical connector according to an embodiment of the present application.

FIG. 4 is a cross-sectional schematic view taken along line AA of a partial component of the electrical connector shown in FIG. 3.

FIG. 5 is a cross-sectional schematic view taken along line BB of a partial component of the electrical connector shown in FIG. 3.

FIG. 6 is a cross-sectional schematic view taken along line CC of a partial component of the electrical connector shown in FIG. 3.

FIG. 7 is a perspective schematic view of a partial component of the electrical connector according to an embodiment of the present application from a first viewing angle.

FIG. 8 is a perspective schematic view of a partial component of the electrical connector according to an embodiment of the present application from a second viewing angle.

FIG. 9 is a perspective schematic view of a partial component of the electrical connector according to an embodiment of the present application from a first viewing angle.

FIG. 10 is a perspective schematic view of a partial component of the electrical connector according to an embodiment of the present application from a second viewing angle.

FIG. 11 is a perspective schematic view of a partial component of the electrical connector according to an embodiment of the present application from a first viewing angle.

FIG. 12 is a perspective schematic view of a partial component of the electrical connector according to an embodiment of the present application from a second viewing angle.

FIG. 13 is a perspective schematic view of a partial component of the electrical connector according to an embodiment of the present application from a first viewing angle.

FIG. 14 is a perspective schematic view of a partial component of the electrical connector according to an embodiment of the present application from a second viewing angle.

FIG. 15 is a perspective schematic view of a partial component of the electrical connector according to an embodiment of the present application from a first viewing angle.

FIG. 16 is a perspective schematic view of a partial component of the electrical connector according to an embodiment of the present application from a second viewing angle.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, it should be noted that, in order to make the disclosure more concise and easier to understand, components comprising identical or similar functions in the following embodiments will be designated by the same reference numerals, and descriptions of identical or equivalent features will be omitted.

The present application provides at least one electrical connector, which comprises a major conductive terminal, a minor-side conductive terminal, and a conductive shielding material component. The conductive shielding material component is disposed between the major conductive terminal and the minor-side conductive terminal, and comprises a conductive plastic material and a conductive metal material, wherein the conductive plastic material and the conductive metal material are electrically connected to transmit shielding signals, thereby providing shielding for signal transmission between the major conductive terminal and the minor-side conductive terminal. In this manner, interference encountered by the electrical connector when transmitting high-speed signals can be effectively reduced, thereby optimizing the quality of high-speed signal transmission and meeting the special demands and development trends of electronic devices.

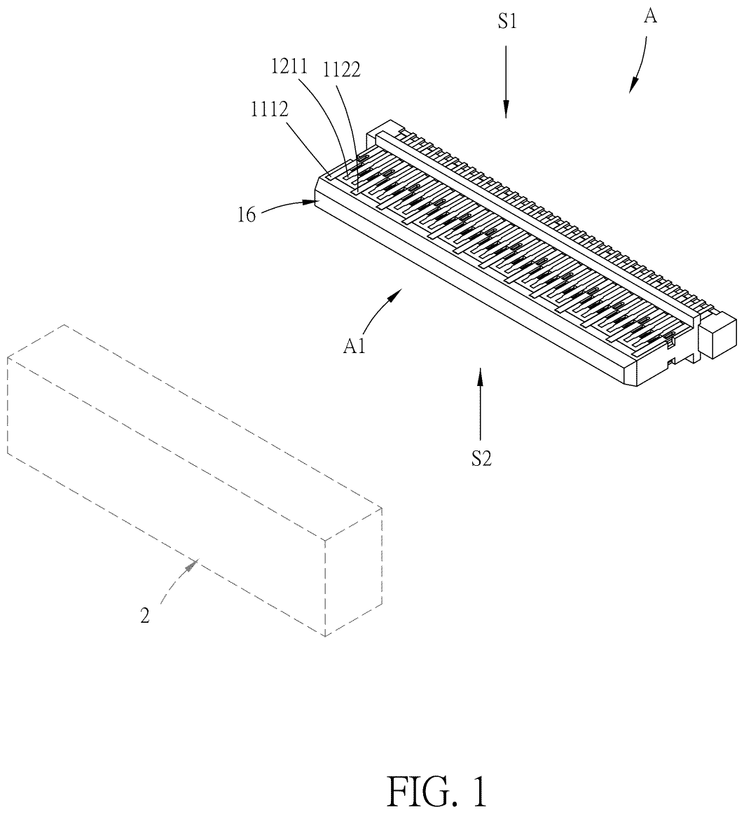

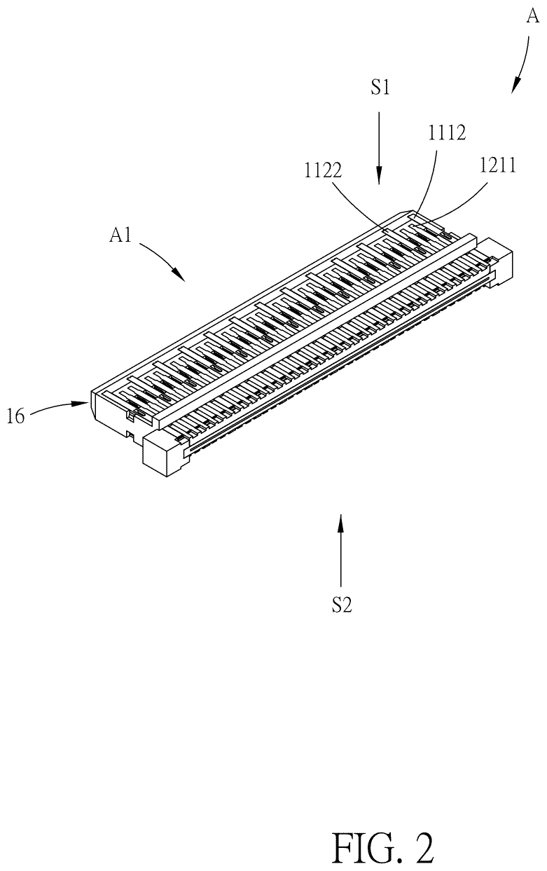

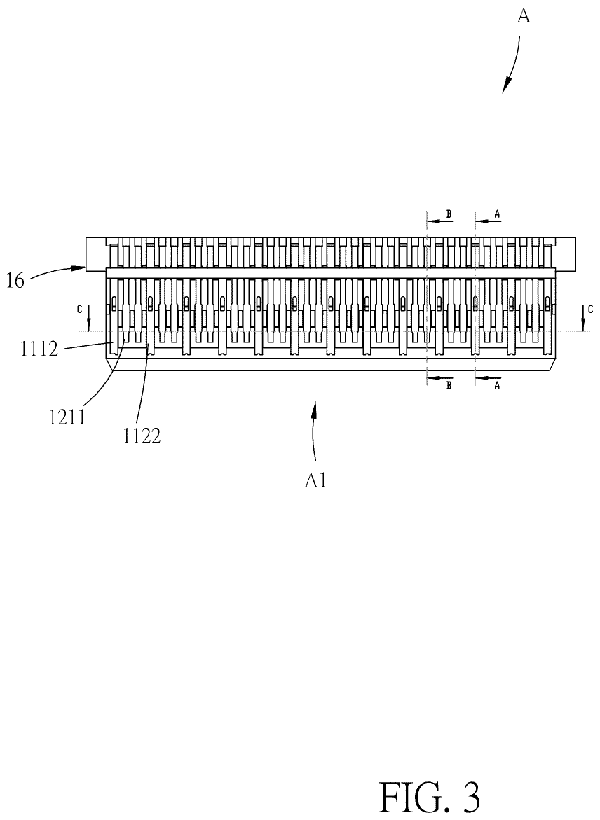

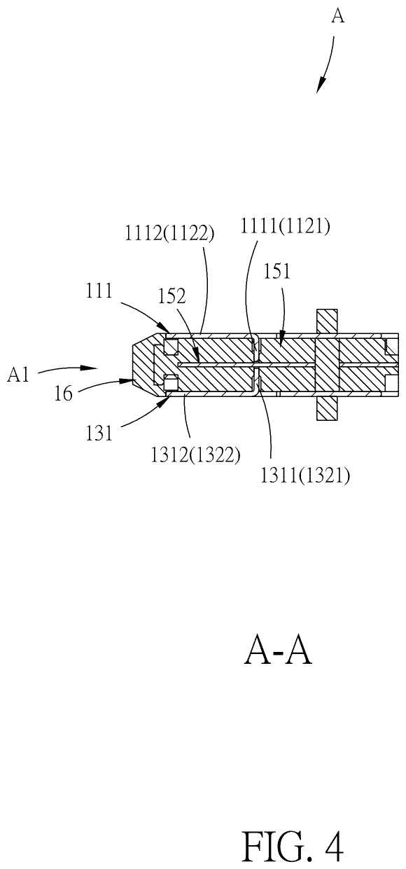

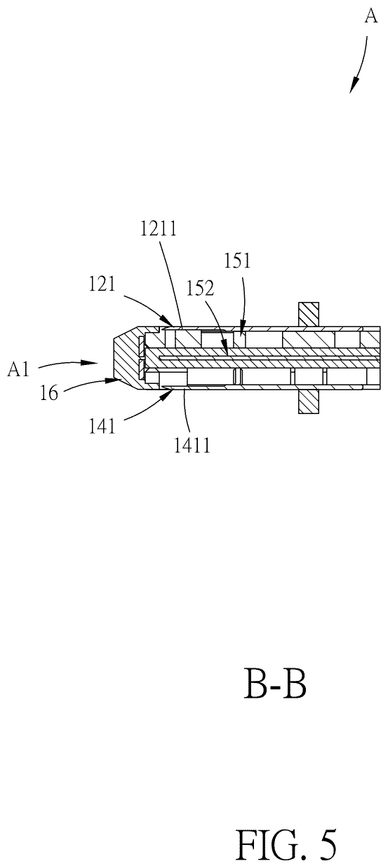

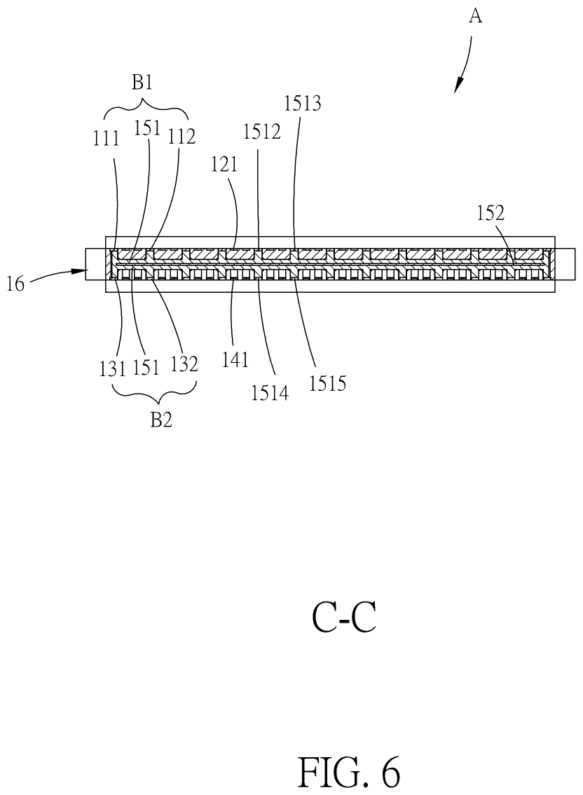

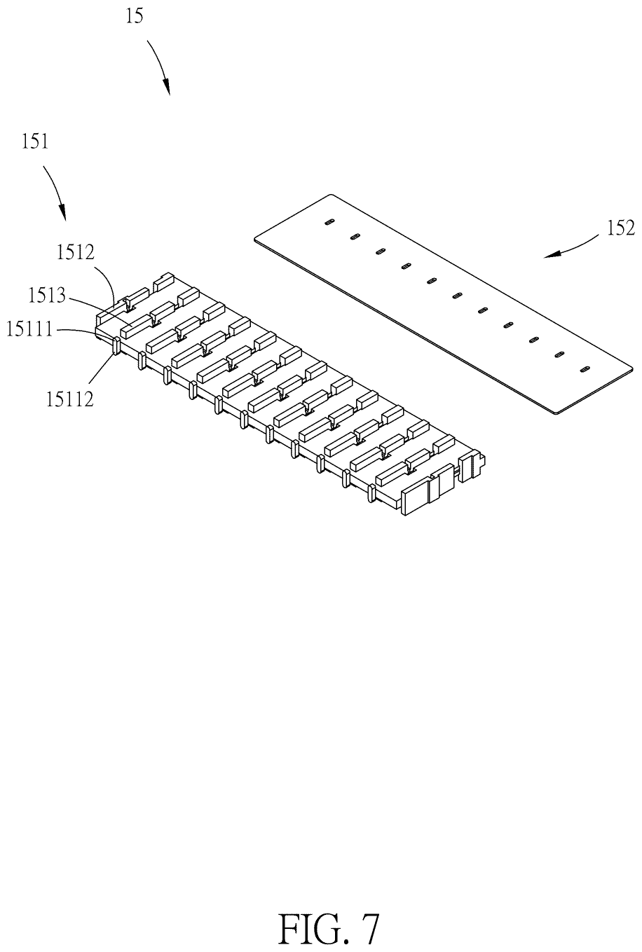

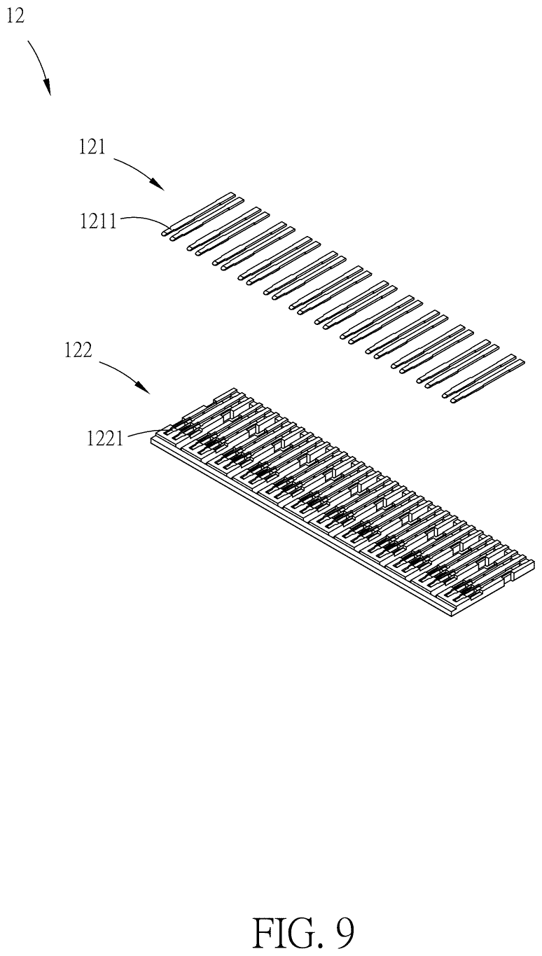

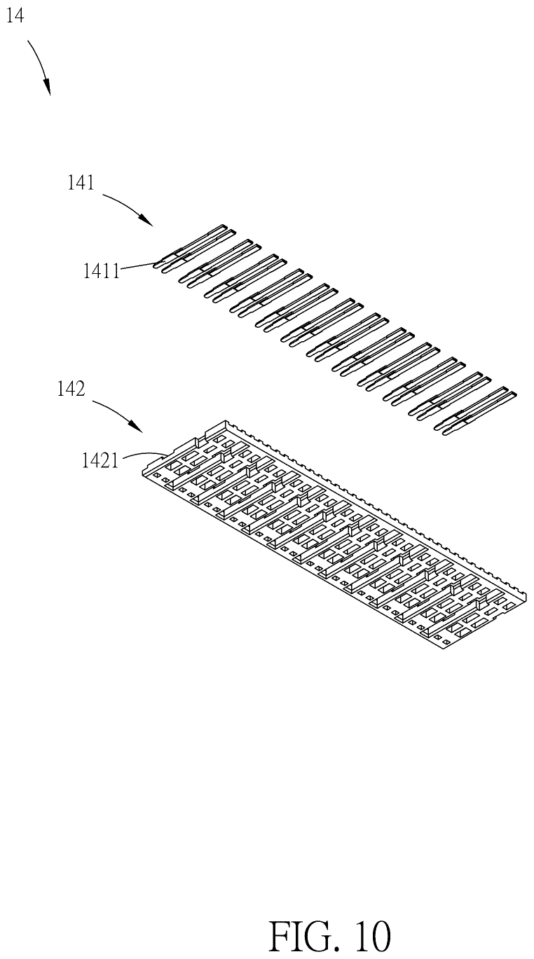

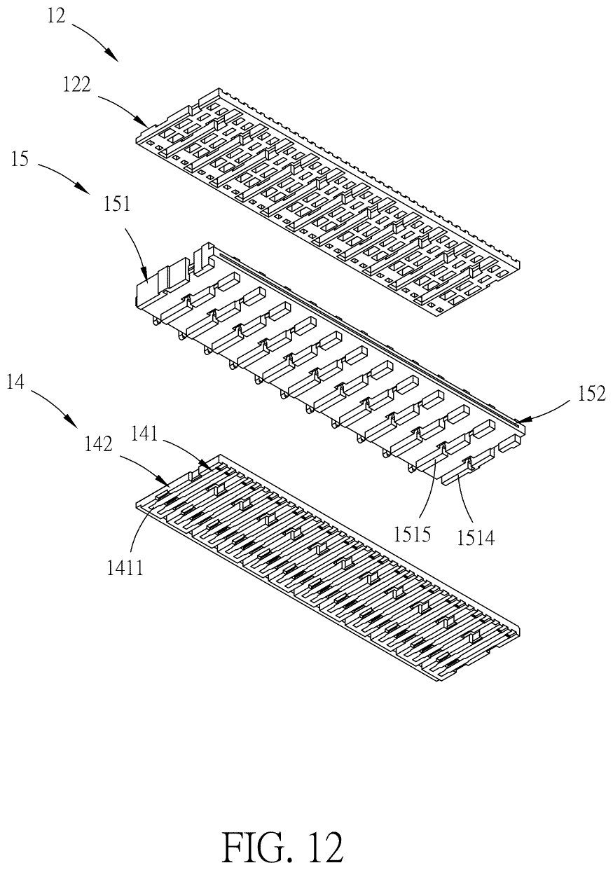

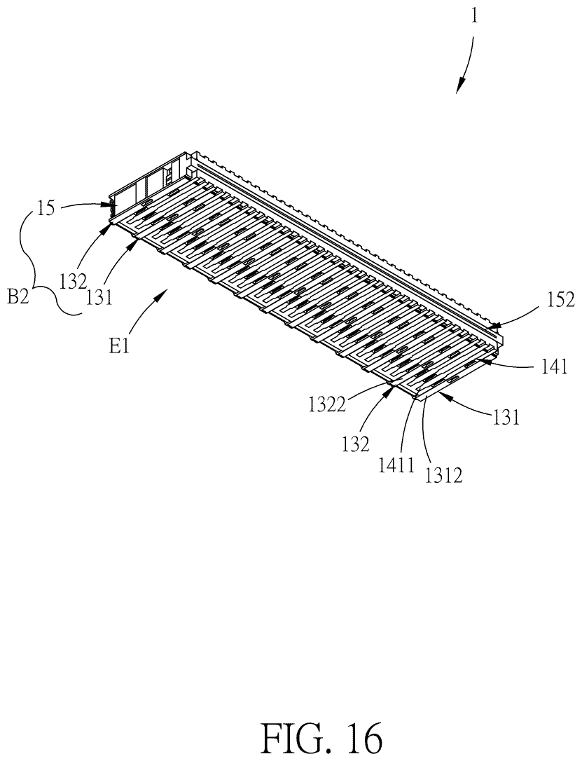

For a detailed description of the embodiments disclosed in the present application, please refer to FIGS. 1 to 16.

In the above embodiments, an electrical connector 1 configured to be installed in an electronic device is provided. In the electronic device, the electrical connector 1 can be mated at an electrical connector joining end E1 with a joining component 2 to transmit signals. It should be noted that two sides of the electrical connector 1 can be respectively defined as an electrical connector major side S1 and an electrical connector minor side S2. The joining component 2 may be, for example, a mating connector or a mating circuit board.

In the embodiments illustrated in FIGS. 1 to 16, the electrical connector 1 comprises: a major shielding terminal component 11, a major non-shielding terminal component 12, a minor shielding terminal component 13, a minor non-shielding terminal component 14, a conductive shielding material component 15, and an electrical connector core 16.

As for the major shielding terminal component 11, it comprises a first major shielding conductive terminal 111, a second major shielding conductive terminal 112, and a major shielding terminal conductive connector 113. The major shielding terminal conductive connector 113 is electrically connected to the first major shielding conductive terminal 111 and the second major shielding conductive terminal 112, respectively. The first major shielding conductive terminal 111 comprises a first major shielding terminal joining structure 1112, while the second major shielding conductive terminal 112 comprises a second major shielding terminal joining structure 1122.

It should be noted that the first major shielding conductive terminal 111 and the second major shielding conductive terminal 112 are comprised of metal materials and are configured to transmit shielding signals such as grounding signals. Moreover, the number of the first major shielding conductive terminal 111 and the second major shielding conductive terminal 112 is not limited to one.

As for the major non-shielding terminal component 12, the major non-shielding terminal component 12 comprises a major non-shielding conductive terminal 121 and a major non-shielding terminal component insulator 122, wherein the major non-shielding terminal component insulator 122 can be comprised of insulating materials and can be mated with the major non-shielding conductive terminal 121. The major non-shielding conductive terminal 121 comprises a major non-shielding conductive terminal joining structure 1211, and the major non-shielding terminal component insulator 122 comprises a major non-shielding terminal component insulator terminal base 1221.

It should be noted that the major non-shielding conductive terminal 121 is comprised of metal materials and is configured to transmit non-shielded signals such as differential signals. Moreover, the number of the major non-shielding conductive terminal 121 is not limited to one.

As for the minor shielding terminal component 13, the minor shielding terminal component 13 comprises a first minor shielding conductive terminal 131, a second minor shielding conductive terminal 132, and a minor shielding terminal conductive connector 133, wherein the minor shielding terminal conductive connector 133 is electrically connected to the first minor shielding conductive terminal 131 and the second minor shielding conductive terminal 132, respectively. The first minor shielding conductive terminal 131 comprises a first minor shielding terminal joining structure 1312, and the second minor shielding conductive terminal 132 comprises a second minor shielding terminal joining structure 1322.

It should be noted that the first minor shielding conductive terminal 131 and the second minor shielding conductive terminal 132 are comprised of metal materials and are configured to transmit shielding signals such as grounding signals. Moreover, the number of the first minor shielding conductive terminal 131 and the second minor shielding conductive terminal 132 is not limited to one.

As for the minor non-shielding terminal component 14, the minor non-shielding terminal component 14 comprises a minor non-shielding conductive terminal 141 and a minor non-shielding terminal component insulator 142, wherein the minor non-shielding terminal component insulator 142 can be comprised of insulating materials and can be mated with the minor non-shielding conductive terminal 141. The minor non-shielding conductive terminal 141 comprises a minor non-shielding conductive terminal joining structure 1411, and the minor non-shielding terminal component insulator 142 comprises a minor non-shielding terminal component insulator terminal base 1421.

It should be noted that the minor non-shielding conductive terminal 141 is comprised of metal materials and is configured to transmit non-shielded signals such as differential signals. Moreover, the number of the minor non-shielding conductive terminal 141 is not limited to one.

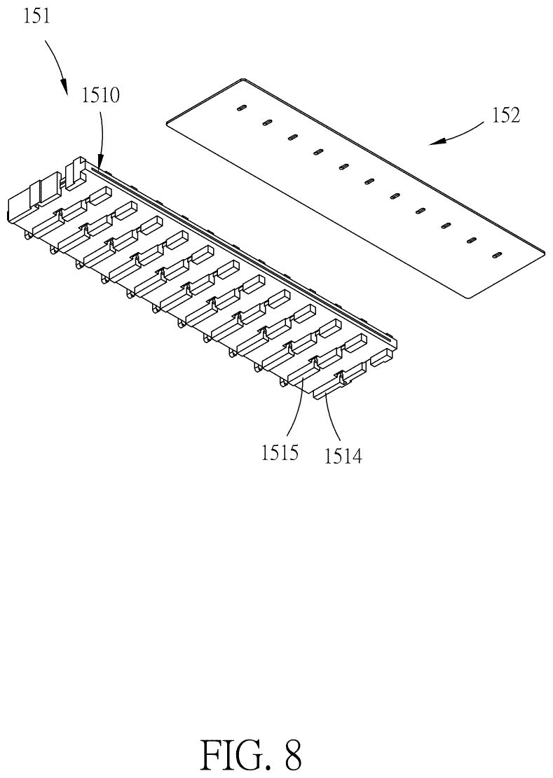

As for the conductive shielding material component 15, the conductive shielding material component 15 comprises a conductive plastic material 151 and a conductive metal material 152. The conductive plastic material 151 can be comprised of conductive plastic materials, and the conductive metal material 152 can be comprised of conductive metal materials. The conductive plastic material 151 can be electrically mated with the conductive metal material 152 such that the conductive plastic material 151 and the conductive metal material 152 are electrically connected to transmit shielding signals such as grounding signals. In the embodiment illustrated in FIG. 8, the conductive plastic material 151 comprises a conductive plastic material inner space 1510, and the conductive metal material 152 can extend into the conductive plastic material inner space 1510 between the major non-shielding terminal component 12 and the minor non-shielding terminal component 14, thereby providing an electrically shielded environment for signal transmission between the major non-shielding terminal component 12 and the minor non-shielding terminal component 14. In this manner, interference encountered by the electrical connector 1 when transmitting high-speed signals can be effectively reduced, thereby optimizing the quality of high-speed signal transmission and meeting the special demands and development trends of electronic devices.

Additionally, the conductive plastic material 151 comprises a first major conductive plastic material shielding terminal base 1512, a second major conductive plastic material shielding terminal base 1513, a first minor conductive plastic material shielding terminal base 1514, and a second minor conductive plastic material shielding terminal base 1515.

As for the electrical connector core 16, the electrical connector core 16 can be comprised of insulating materials and can be mated with the major shielding terminal component 11, the major non-shielding terminal component 12, the minor shielding terminal component 13, the minor non-shielding terminal component 14, and the conductive shielding material component 15 to form an electrical connector mating component A. In the embodiment illustrated in FIGS. 1 to 5, the electrical connector mating component A comprises an electrical connector mating component joining portion A1, which can provide mating with the joining component 2.

It should be noted that the major non-shielding terminal component insulator terminal base 1221 can provide support for the major non-shielding conductive terminal 121, thereby reducing the degree of deformation of the major non-shielding conductive terminal 121, so that the major non-shielding conductive terminal joining structure 1211 can be positioned at the electrical connector mating component joining portion A1 to provide mating with the joining component 2. The first major conductive plastic material shielding terminal base 1512 can pass through the major non-shielding terminal component insulator 122 to provide support for the first major shielding conductive terminal 111, and the second major conductive plastic material shielding terminal base 1513 can pass through the major non-shielding terminal component insulator 122 to provide support for the second major shielding conductive terminal 112, thereby reducing the degree of deformation of the first major shielding conductive terminal 111 and the second major shielding conductive terminal 112, so that the major non-shielding conductive terminal joining structure 1211, the first major shielding terminal joining structure 1112, and the second major shielding terminal joining structure 1122 can respectively be positioned at the electrical connector mating component joining portion A1 to provide mating with the joining component 2 and transmit electrical signals.

Additionally, the minor non-shielding terminal component insulator terminal base 1421 can provide support for the minor non-shielding conductive terminal 141, thereby reducing the degree of deformation of the minor non-shielding conductive terminal 141, so that the minor non-shielding conductive terminal joining structure 1411 can be positioned at the electrical connector mating component joining portion A1 to provide mating with the joining component 2. The first minor conductive plastic material shielding terminal base 1514 can pass through the minor non-shielding terminal component insulator 142 to provide support for the first minor shielding conductive terminal 131, and the second minor conductive plastic material shielding terminal base 1515 can pass through the minor non-shielding terminal component insulator 142 to provide support for the second minor shielding conductive terminal 132, thereby reducing the degree of deformation of the first minor shielding conductive terminal 131 and the second minor shielding conductive terminal 132, so that the minor non-shielding conductive terminal joining structure 1411, the first minor shielding terminal joining structure 1312, and the second minor shielding terminal joining structure 1322 can respectively be positioned at the electrical connector mating component joining portion A1 to provide mating with the joining component 2 and transmit electrical signals.

In the electrical connector mating component A, the major non-shielding terminal component 12 and the major shielding terminal component 11 can respectively bridge over the conductive shielding material component 15, so that the major non-shielding terminal component 12 and the major shielding terminal component 11 are respectively disposed at the electrical connector major side S1. The major non-shielding terminal component insulator 122 electrically isolates the major non-shielding conductive terminal 121 from the conductive shielding material component 15, thereby preventing the major non-shielding conductive terminal 121 from being electrically connected to the conductive shielding material component 15. Moreover, the major non-shielding terminal component insulator 122 also electrically isolates the major non-shielding conductive terminal 121 from the major shielding terminal component 11, thereby preventing the major non-shielding conductive terminal 121 from being electrically connected to the major shielding terminal component 11.

It should be noted that, optionally, the major non-shielding terminal component insulator 122 can be mated with the conductive plastic material 151 to maintain the state in which the major non-shielding terminal component 12 bridges over the conductive shielding material component 15. Additionally, the first major shielding conductive terminal 111 and the second major shielding conductive terminal 112 can respectively abut against the major non-shielding terminal component insulator 122 to maintain the state in which the major non-shielding terminal component 12 bridges over the conductive shielding material component 15.

Additionally, in the electrical connector mating component A, the major shielding terminal component 11 can be electrically inserted into the conductive plastic material 151, thereby electrically connecting the major shielding terminal component 11 to the conductive plastic material 151 to transmit shielding signals.

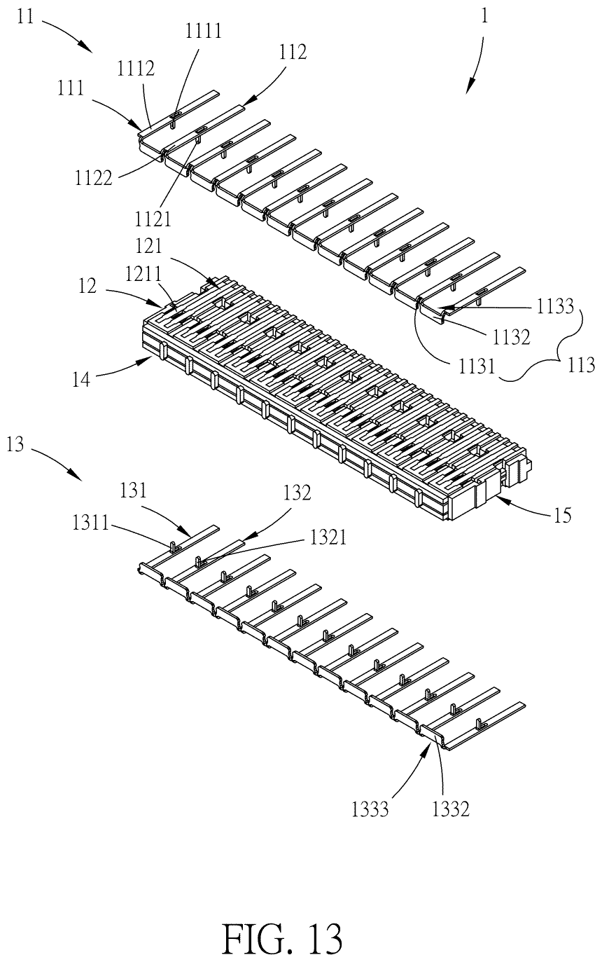

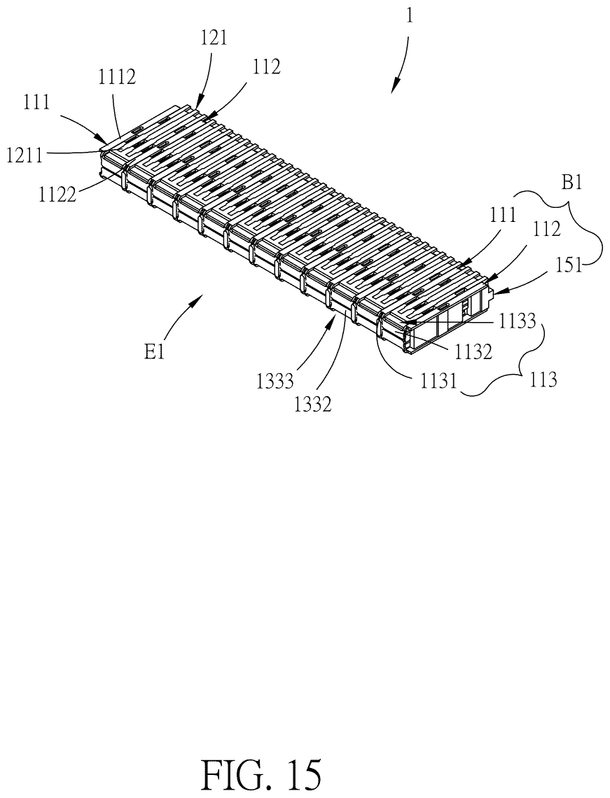

Optionally, in the embodiments illustrated in FIGS. 13 and 15, the first major shielding conductive terminal 111 comprises a first major shielding terminal inserting structure 1111, and the second major shielding conductive terminal 112 comprises a second major shielding terminal inserting structure 1121. The first major shielding terminal inserting structure 1111 and the second major shielding terminal inserting structure 1121 are respectively electrically inserted into the conductive plastic material 151, thereby electrically connecting the major shielding terminal component 11 to the conductive plastic material 151 to transmit shielding signals.

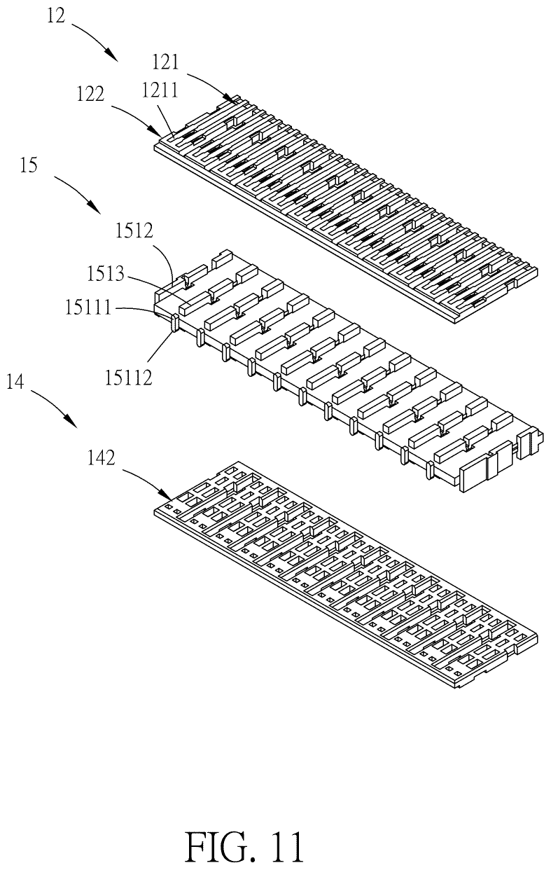

Optionally, in the embodiments illustrated in FIGS. 11 to 14, the conductive plastic material 151 can pass through the major non-shielding terminal component insulator 122 and be respectively electrically bridged to the first major shielding conductive terminal 111 and the second major shielding conductive terminal 112, so that the conductive plastic material 151, the first major shielding conductive terminal 111, and the second major shielding conductive terminal 112 constitute a major conductive shielding body B1 capable of transmitting shielding signals. The major conductive shielding body B1 extends near the major non-shielding conductive terminal 121 to provide a shielding environment for the signal transmission of the major non-shielding conductive terminal 121, thereby reducing the interference encountered by the electrical connector 1 during high-speed signal transmission and optimizing the quality of high-speed signal transmission to meet the special demands and development trends of electronic devices.

Furthermore, in the electrical connector mating component A, the minor non-shielding terminal component 14 and the minor shielding terminal component 13 can respectively bridge over the conductive shielding material component 15, so that the minor non-shielding terminal component 14 and the minor shielding terminal component 13 are respectively disposed at the electrical connector minor side S2. The minor non-shielding terminal component insulator 142 electrically isolates the minor non-shielding conductive terminal 141 from the conductive shielding material component 15, thereby preventing the minor non-shielding conductive terminal 141 from being electrically connected to the conductive shielding material component 15. Moreover, the minor non-shielding terminal component insulator 142 also electrically isolates the minor non-shielding conductive terminal 141 from the minor shielding terminal component 13, thereby preventing the minor non-shielding conductive terminal 141 from being electrically connected to the minor shielding terminal component 13.

It should be noted that, optionally, the minor non-shielding terminal component insulator 142 can be mated with the conductive plastic material 151 to maintain the state in which the minor non-shielding terminal component 14 bridges over the conductive shielding material component 15. Additionally, the first minor shielding conductive terminal 131 and the second minor shielding conductive terminal 132 can respectively abut against the minor non-shielding terminal component insulator 142 to maintain the state in which the minor non-shielding terminal component 14 bridges over the conductive shielding material component 15.

Additionally, in the electrical connector mating component A, the minor shielding terminal component 13 can be electrically inserted into the conductive plastic material 151, thereby electrically connecting the minor shielding terminal component 13 to the conductive plastic material 151 to transmit shielding signals.

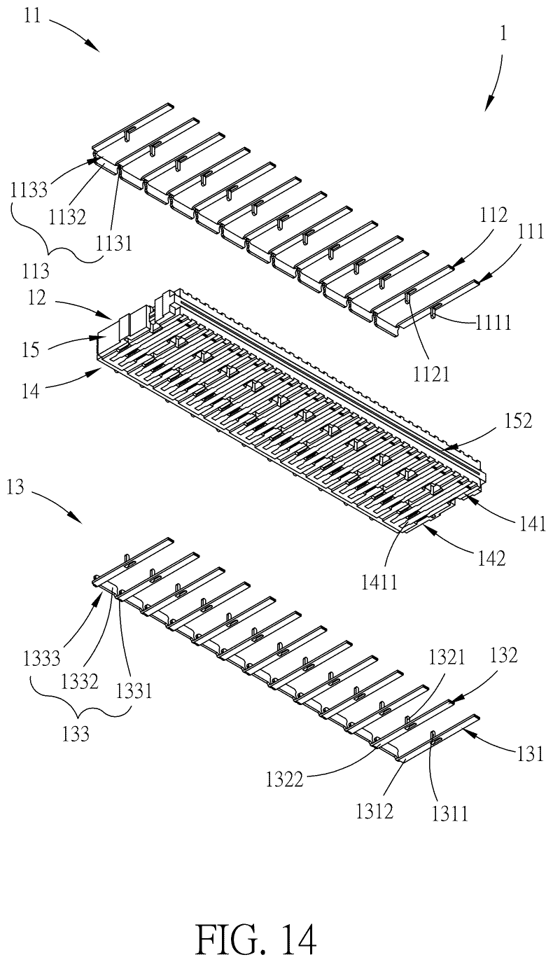

Optionally, in the embodiments illustrated in FIGS. 13 to 14, the first minor shielding conductive terminal 131 comprises a first minor shielding terminal inserting structure 1311, and the second minor shielding conductive terminal 132 comprises a second minor shielding terminal inserting structure 1321. The first minor shielding terminal inserting structure 1311 and the second minor shielding terminal inserting structure 1321 are respectively electrically inserted into the conductive plastic material 151, thereby electrically connecting the minor shielding terminal component 13 to the conductive plastic material 151 to transmit shielding signals.

Optionally, in the embodiments illustrated in FIGS. 11 to 12 and FIG. 14, the conductive plastic material 151 can pass through the minor non-shielding terminal component insulator 142 and be respectively electrically bridged to the first minor shielding conductive terminal 131 and the second minor shielding conductive terminal 132, so that the conductive plastic material 151, the first minor shielding conductive terminal 131, and the second minor shielding conductive terminal 132 constitute a minor conductive shielding body B2 capable of transmitting shielding signals. The minor conductive shielding body B2 extends near the minor non-shielding conductive terminal 141 to provide a shielding environment for the signal transmission of the minor non-shielding conductive terminal 141, thereby reducing the interference encountered by the electrical connector 1 during high-speed signal transmission and optimizing the quality of high-speed signal transmission to meet the special demands and development trends of electronic devices.

Optionally, in the embodiments illustrated in FIGS. 11 to 15, the major shielding terminal conductive connector 113 comprises a major shielding terminal conductive connector inserting structure 1131, and the minor shielding terminal conductive connector 133 comprises a minor shielding terminal conductive connector inserting structure 1331. Correspondingly, the conductive plastic material 151 comprises a major conductive plastic material inserting block 15111 and a minor conductive plastic material inserting block 15112. It should be noted that the major conductive plastic material inserting block 15111 provides electrical insertion for the major shielding terminal conductive connector inserting structure 1131, and the minor conductive plastic material inserting block 15112 be electrically inserted into the minor shielding terminal conductive connector inserting structure 1331 to transmit shielding signals. Furthermore, the major conductive plastic material inserting block 15111 and the minor conductive plastic material inserting block 15112 can be integrated into a single piece.

Optionally, the major shielding terminal conductive connector 113 comprises a major shielding terminal conductive connector shielding structure 1132 and a major shielding terminal conductive connector perforated structure 1133. In the embodiment illustrated in FIG. 15, the major shielding terminal conductive connector shielding structure 1132 is disposed at the electrical connector joining end E1 and extends near the major non-shielding conductive terminal joining structure 1211 to provide a shielding environment for the signal transmission of the major non-shielding conductive terminal joining structure 1211, thereby reducing the interference encountered by the electrical connector 1 during high-speed signal transmission and optimizing the quality of high-speed signal transmission to meet the special demands and development trends of electronic devices. Moreover, the major shielding terminal conductive connector perforated structure 1133 is disposed at the electrical connector joining end E1 to provide impedance matching for the signal transmission of the major non-shielding conductive terminal joining structure 1211.

Additionally, optionally, the minor shielding terminal conductive connector 133 comprises a minor shielding terminal conductive connector shielding structure 1332 and a minor shielding terminal conductive connector perforated structure 1333. In the embodiment illustrated in FIG. 15, the minor shielding terminal conductive connector shielding structure 1332 is disposed at the electrical connector joining end E1 and extends near the minor non-shielding conductive terminal joining structure 1411 to provide a shielding environment for the signal transmission of the minor non-shielding conductive terminal joining structure 1411, thereby reducing the interference encountered by the electrical connector 1 during high-speed signal transmission and optimizing the quality of high-speed signal transmission to meet the special demands and development trends of electronic devices. Moreover, the minor shielding terminal conductive connector perforated structure 1333 is disposed at the electrical connector joining end E1 to provide impedance matching for the signal transmission of the minor non-shielding conductive terminal joining structure 1411.

Furthermore, in the electrical connector mating component A, the conductive metal material 152 is disposed between the major non-shielding terminal component 12 and the minor non-shielding terminal component 14 to provide shielding for the signal transmission between the major non-shielding conductive terminal 121 and the minor non-shielding conductive terminal 141.

It should be noted that, in the embodiments of the present application, certain components described above can be omitted as needed. For example, the electrical connector may comprise: a major shielding terminal component, a major non-shielding terminal component, a minor shielding terminal component, a minor non-shielding terminal component, and a conductive shielding material component. The major shielding terminal component comprises a first major shielding conductive terminal, a second major shielding conductive terminal, and a major shielding terminal conductive connector, wherein the major shielding terminal conductive connector is electrically connected to the first major shielding conductive terminal and the second major shielding conductive terminal, respectively. The major non-shielding terminal component comprises a major non-shielding conductive terminal and a major non-shielding terminal component insulator, wherein the major non-shielding terminal component insulator can be mated with the major non-shielding conductive terminal. The minor shielding terminal component comprises a first minor shielding conductive terminal, a second minor shielding conductive terminal, and a minor shielding terminal conductive connector, wherein the minor shielding terminal conductive connector is electrically connected to the first minor shielding conductive terminal and the second minor shielding conductive terminal, respectively. The minor non-shielding terminal component comprises a minor non-shielding conductive terminal and a minor non-shielding terminal component insulator, wherein the minor non-shielding terminal component insulator can be mated with the minor non-shielding conductive terminal. The conductive shielding material component comprises a conductive plastic material and a conductive metal material, wherein the conductive plastic material is electrically mated with the conductive metal material to transmit shielding signals. In the structure, the major non-shielding terminal component and the major shielding terminal component can respectively bridge over the conductive shielding material component, so that the major non-shielding terminal component and the major shielding terminal component are respectively disposed at the electrical connector major side. The major non-shielding terminal component insulator electrically isolates the major non-shielding conductive terminal from the conductive shielding material component to prevent electrical connection between the major non-shielding conductive terminal and the conductive shielding material component, and also electrically isolates the major non-shielding conductive terminal from the major shielding terminal component to prevent electrical connection between the major non-shielding conductive terminal and the major shielding terminal component. The major shielding terminal component can be electrically inserted into the conductive plastic material to transmit shielding signals. Similarly, the minor non-shielding terminal component and the minor shielding terminal component can respectively bridge over the conductive shielding material component, so that the minor non-shielding terminal component and the minor shielding terminal component are respectively disposed at the electrical connector minor side. The minor non-shielding terminal component insulator electrically isolates the minor non-shielding conductive terminal from the conductive shielding material component to prevent electrical connection between the minor non-shielding conductive terminal and the conductive shielding material component, and also electrically isolates the minor non-shielding conductive terminal from the minor shielding terminal component to prevent electrical connection between the minor non-shielding conductive terminal and the minor shielding terminal component. The minor shielding terminal component can be electrically inserted into the conductive plastic material to transmit shielding signals. Moreover, the conductive metal material is disposed between the major non-shielding terminal component and the minor non-shielding terminal component to provide shielding for the signal transmission between the major non-shielding conductive terminal and the minor non-shielding conductive terminal.

In summary, the electrical connector of the present application comprises a major shielding conductive terminal, a major non-shielding conductive terminal, a minor shielding conductive terminal, a minor non-shielding conductive terminal, and a conductive shielding material component. The conductive shielding material component is disposed between the major conductive terminal and the minor-side conductive terminal, and comprises a conductive plastic material and a conductive metal material, wherein the conductive plastic material, the conductive metal material, the major shielding conductive terminal, and the minor shielding conductive terminal are electrically connected to transmit shielding signals. Thus, the conductive plastic material, the conductive metal material, the major shielding conductive terminal, and the minor shielding conductive terminal provide shielding for the signal transmission between the major non-shielding conductive terminal and the minor non-shielding conductive terminal, thereby effectively reducing interference encountered by the electrical connector during high-speed signal transmission and optimizing the quality of high-speed signal transmission to meet the special demands and development trends of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

1. An electrical connector comprising an electrical connector major side and an electrical connector minor side, the electrical connector comprising:
a major shielding terminal component comprising a first major shielding conductive terminal, a second major shielding conductive terminal, and a major shielding terminal conductive connector, wherein the major shielding terminal conductive connector is electrically connected to the first major shielding conductive terminal and the second major shielding conductive terminal respectively;
a major non-shielding terminal component comprising a major non-shielding conductive terminal and a major non-shielding terminal component insulator, wherein the major non-shielding terminal component insulator is mated with the major non-shielding conductive terminal;
a minor shielding terminal component comprising a first minor shielding conductive terminal, a second minor shielding conductive terminal, and a minor shielding terminal conductive connector, wherein the minor shielding terminal conductive connector is electrically connected to the first minor shielding conductive terminal and the second minor shielding conductive terminal respectively;
a minor non-shielding terminal component comprising a minor non-shielding conductive terminal and a minor non-shielding terminal component insulator, wherein the minor non-shielding terminal component insulator is mated with the minor non-shielding conductive terminal; and
a conductive shielding material component comprising a conductive plastic material and a conductive metal material, wherein the conductive plastic material is electrically mated with the conductive metal material to transmit shielding signals; wherein,
the major non-shielding terminal component and the major shielding terminal component are respectively configured to be bridged across the conductive shielding material component and are respectively located at the electrical connector major side, wherein the major non-shielding terminal component insulator is configured to electrically isolate the major non-shielding conductive terminal from the conductive shielding material component to prevent electrical connection between the major non-shielding conductive terminal and the conductive shielding material component, and the major non-shielding terminal component insulator is further configured to electrically isolate the major non-shielding conductive terminal from the major shielding terminal component to prevent electrical connection between the major non-shielding conductive terminal and the major shielding terminal component;
the major shielding terminal component is configured to be electrically inserted into the conductive plastic material to transmit shielding signals;
the minor non-shielding terminal component and the minor shielding terminal component are respectively configured to be bridged across the conductive shielding material component and are respectively located at the electrical connector minor side, wherein the minor non-shielding terminal component insulator is configured to isolate the minor non-shielding conductive terminal from the conductive shielding material component to prevent electrical connection between the minor non-shielding conductive terminal and the conductive shielding material component, and the minor non-shielding terminal component insulator is further configured to isolate the minor non-shielding conductive terminal from the minor shielding terminal component to prevent electrical connection between the minor non-shielding conductive terminal and the minor shielding terminal component;
the minor shielding terminal component is configured to be electrically inserted into the conductive plastic material to transmit shielding signals; and
the conductive metal material is disposed between the major non-shielding terminal component and the minor non-shielding terminal component to provide shielding for signal transmission between the major non-shielding conductive terminal and the minor non-shielding conductive terminal.

2. The electrical connector of claim 1, wherein the conductive plastic material, the first major shielding conductive terminal, and the second major shielding conductive terminal are configured to form a major conductive shielding body, wherein the major conductive shielding body comprises a U-shaped form and is extended near the major non-shielding conductive terminal; and the conductive plastic material, the first minor shielding conductive terminal, and the second minor shielding conductive terminal are configured to form a minor conductive shielding body, wherein the minor conductive shielding body comprises a U-shaped form and is extended near the major non-shielding conductive terminal.

3. The electrical connector of claim 1, further comprising an electrical connector core, wherein the electrical connector core is configured to be mated with the major shielding terminal component, the major non-shielding terminal component, the minor shielding terminal component, the minor non-shielding terminal component, and the conductive shielding material component so as to form an electrical connector mating component.

4. The electrical connector of claim 1, wherein the conductive plastic material is configured to pass through the major non-shielding terminal component insulator to be electrically connected to the first major shielding conductive terminal and the second major shielding conductive terminal respectively, so as to transmit shielding signals and provide shielding for signal transmission of the major non-shielding conductive terminal; and the conductive plastic material is further configured to pass through the minor non-shielding terminal component insulator to be electrically connected to the first minor shielding conductive terminal and the second minor shielding conductive terminal respectively, so as to transmit shielding signals and provide shielding for signal transmission of the minor non-shielding conductive terminal.

5. The electrical connector of claim 1, wherein the conductive plastic material comprises a conductive plastic material inner space, and the conductive metal material is configured to be extended within the conductive plastic material inner space.

6. The electrical connector of claim 1, wherein the first major shielding conductive terminal and the second major shielding conductive terminal respectively comprise a first major shielding terminal inserting structure and a second major shielding terminal inserting structure, allowing the first major shielding terminal inserting structure and the second major shielding terminal inserting structure to be electrically inserted into the conductive plastic material respectively; and the first minor shielding conductive terminal and the second minor shielding conductive terminal respectively comprise a first minor shielding terminal inserting structure and a second minor shielding terminal inserting structure, allowing the first minor shielding terminal inserting structure and the second minor shielding terminal inserting structure to be electrically inserted into the conductive plastic material respectively.

7. The electrical connector of claim 1, wherein the major shielding terminal conductive connector comprises a major shielding terminal conductive connector inserting structure configured to be electrically inserted into the conductive plastic material to transmit shielding signals; and the minor shielding terminal conductive connector comprises a minor shielding terminal conductive connector inserting structure configured to be electrically inserted into the conductive plastic material to transmit shielding signals.

8. The electrical connector of claim 7, wherein the conductive plastic material comprises a major conductive plastic material inserting block and a minor conductive plastic material inserting block, allowing the major conductive plastic material inserting block and the minor conductive plastic material inserting block to respectively be electrically inserted into the major shielding terminal conductive connector inserting structure and the minor shielding terminal conductive connector inserting structure to transmit shielding signals.

9. The electrical connector of claim 8, wherein the major conductive plastic material inserting block and the minor conductive plastic material inserting block are integrally formed.

10. The electrical connector of claim 3, configured to be mated with a joining component at an electrical connector joining end, wherein the electrical connector mating component comprises an electrical connector mating component joining portion, the major non-shielding conductive terminal comprises a major non-shielding conductive terminal joining structure, the first major shielding conductive terminal comprises a first major shielding terminal joining structure, and the second major shielding conductive terminal comprises a second major shielding terminal joining structure; wherein the major non-shielding terminal component insulator comprises a major non-shielding terminal component insulator terminal base, and the conductive plastic material comprises a first major conductive plastic material shielding terminal base and a second major conductive plastic material shielding terminal base; wherein the major non-shielding terminal component insulator terminal base is configured to support the major non-shielding conductive terminal, the first major conductive plastic material shielding terminal base is configured to support the first major shielding conductive terminal, and the second major conductive plastic material shielding terminal base is configured to support the second major shielding conductive terminal, such that the major non-shielding conductive terminal joining structure, the first major shielding terminal joining structure, and the second major shielding terminal joining structure are respectively located at the electrical connector mating component joining portion to be mated with the joining component.

11. The electrical connector of claim 10, wherein the first major conductive plastic material shielding terminal base and the second major conductive plastic material shielding terminal base are configured to respectively pass through the major non-shielding terminal component insulator to respectively support the first major shielding conductive terminal and the second major shielding conductive terminal.

12. The electrical connector of claim 10, wherein the major shielding terminal conductive connector comprises a major shielding terminal conductive connector shielding structure located at the electrical connector joining end to provide shielding for signal transmission of the major non-shielding conductive terminal joining structure.

13. The electrical connector of claim 10, wherein the major shielding terminal conductive connector comprises a major shielding terminal conductive connector perforated structure located at the electrical connector joining end to provide impedance matching for signal transmission of the major non-shielding conductive terminal joining structure.

14. The electrical connector of claim 3, configured to be mated with a joining component at an electrical connector joining end, wherein the electrical connector mating component comprises an electrical connector mating component joining portion, the minor non-shielding conductive terminal comprises a minor non-shielding conductive terminal joining structure, the first minor shielding conductive terminal comprises a first minor shielding terminal joining structure, and the second minor shielding conductive terminal comprises a second minor shielding terminal joining structure; wherein the minor non-shielding terminal component insulator comprises a minor non-shielding terminal component insulator terminal base, and the conductive plastic material comprises a first minor conductive plastic material shielding terminal base and a second minor conductive plastic material shielding terminal base; wherein the minor non-shielding terminal component insulator terminal base is configured to support the minor non-shielding conductive terminal, the first minor conductive plastic material shielding terminal base is configured to support the first minor shielding conductive terminal, and the second minor conductive plastic material shielding terminal base is configured to support the second minor shielding conductive terminal, such that the minor non-shielding conductive terminal joining structure, the first minor shielding terminal joining structure, and the second minor shielding terminal joining structure are respectively located at the electrical connector mating component joining portion to be mated with the joining component.

15. The electrical connector of claim 14, wherein the first minor conductive plastic material shielding terminal base is configured to pass through the minor non-shielding terminal component insulator to support the first minor shielding conductive terminal, and the second minor conductive plastic material shielding terminal base is configured to pass through the minor non-shielding terminal component insulator to support the second minor shielding conductive terminal.

16. The electrical connector of claim 14, wherein the minor shielding terminal conductive connector comprises a minor shielding terminal conductive connector shielding structure located at the electrical connector joining end to provide shielding for signal transmission of the minor non-shielding conductive terminal joining structure.

17. The electrical connector of claim 14, wherein the minor shielding terminal conductive connector comprises a minor shielding terminal conductive connector perforated structure located at the electrical connector joining end to provide impedance matching for signal transmission of the minor non-shielding conductive terminal joining structure.

18. The electrical connector of claim 1, wherein the major non-shielding terminal component insulator is configured to be mated with the conductive plastic material so as to maintain the major non-shielding terminal component bridged across the conductive shielding material component; and the minor non-shielding terminal component insulator is configured to be mated with the conductive plastic material so as to maintain the minor non-shielding terminal component bridged across the conductive shielding material component.

19. The electrical connector of claim 1, wherein the first major shielding conductive terminal and the second major shielding conductive terminal are configured to respectively abut the major non-shielding terminal component insulator so as to maintain the major non-shielding terminal component bridged across the conductive shielding material component; and the first minor shielding conductive terminal and the second minor shielding conductive terminal are configured to respectively abut the minor non-shielding terminal component insulator so as to maintain the minor non-shielding terminal component bridged across the conductive shielding material component.
